(19) United States
(12) Patent Application Publication
(10) Pub. No.: US 2013/0295218 A1
(43) Pub. Date: Nov. 7, 2013

(54) MULTILAYER ORIENTED POLYESTER FILM WITH ANTI-STATIC PROPERTY FOR MOLDING PROCESSES

(71) Applicants: Carlos E. HINTON, West Warwick, RI (US); Nao Yokota, North Kingstown, RI (US); Jan Moritz, Bristol, RI (US)

(72) Inventors: Carlos E. HINTON, West Warwick, RI (US); Nao Yokota, North Kingstown, RI (US); Jan Moritz, Bristol, RI (US)

(73) Assignee: TORAY PLASTICS (AMERICA), INC., N. Kingstown, RI (US)

(21) Appl. No.: 13/538,208

(22) Filed: Jun. 29, 2012

Related U.S. Application Data
(60) Provisional application No. 61/643,758, filed on May 7, 2012.

(51) Int. Cl. A21C 11/00; B29C 33/40

(52) U.S. Cl. 425/470; 264/210.1

(57) ABSTRACT

Described are methods for producing biaxially oriented thermoplastic crystallizable films, such as polyester terephthalate (PET) films, that are easy to handle, have at least one surface that can produce high quality finishes in In-Mold Decoration processes (IMD), and have anti-static properties. The static dissipation properties of the film facilitate the manufacture of IMD parts by reducing buildup of debris in the mold and reducing the risk of fire during processing.

### CROSS-REFERENCE TO RELATED APPLICATION

This application claims the benefit of U.S. Provisional Patent Application Ser. No. 61/643,758, filed May 7, 2012, the entire contents of which is incorporated herein by reference.

### FIELD OF INVENTION

This invention relates to ultra smooth multi-layer polyester films that possess antistatic properties, are easy to handle, and methods of making such films. The invention also relates to biaxially oriented films for molding processes.

### BACKGROUND OF INVENTION

Biaxially oriented polyester films can possess thermal stability, dimensional stability, and chemical resistance. End-users in in-mold applications need this stability since the film will be exposed to high temperatures and pressures. In addition these films should possess extremely high smoothness for high gloss and precision stamping of an image on the surface of the transferred parts. These films should possess excellent handling properties. Additionally, the end user often desires that these films have the ability to dissipate static electricity generated during handling and especially during the molding process.

As the smoothness of a plastics film increases its handling becomes increasingly more difficult because the film's coefficient of friction and frictional forces increase and the controllable amount of air entrapped between layers of film in roll formation decreases. Furthermore, as the frictional forces increase with the degree of smoothness, the generation and storage of electrostatic charges increase. This creates a dangerous situation that can cause personnel injuries and/or cause fires that may damage machinery when the charge is violently discharged in an uncontrolled manner.

Some biaxially oriented polyester films for in-mold or stamping applications are known.

EP Publication 551490 describes a film having a peelable layer which is cast onto a polymeric carrier film. This patent states that the layer is easily released with a peel force of 89.2 gr/cm at 148° C.

U.S. Pat. No. 5,882,800 describes a film having an antistatic layer which contains a polyester/polyalkylene oxide and a salt, and a crosslinking agent.

EP Publication 882575 and U.S. Pat. No. 6,103,368 describe a film having an antistatic layer containing an antistatic agent having this recurring unit structure expressed by:

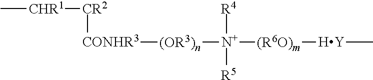

Where, R¹ and R² are each H or CH₃, R³ is an alkylene group having a carbon number of 2 to 10, R⁴ and R⁵ are each a saturated hydrocarbon group having a carbon number of 1 to 5, R⁶ is an alkylene group having a carbon number of 2 to 5, n is a number of 0 to 40, m is a number of 1 to 40, Y⁻ is a halogen ion, a mono- or polyhalogenated alkyl ion, nitrate ion, sulfate ion, an alkylsulfate ion, sulfonate ion or an alkylsulfonate ion.

EP Publication 1176162 describes a film that has imbedded in its matrix extremely elongated discrete domains. These domains consist of 30 to 5% by weight of polyester D obtained from a polycondensation reaction of polyester B comprising a dicarboxylic acid moiety and a glycol moiety and a dehydrated condensate C mainly comprising a glycol, in which the polyester B/dehydrated condensate C mixing ratio falls within the range of 55/45 to 98/2, and 70 to 95% by weight of polyester A comprising ethylene terephthalate as main repeating units, said polyester D being dispersed insularly in polyester A matrix

U.S. Pat. No. 7,544,408 describes a polyester film with one smooth surface and one rough surface. To have antistatic properties, this film would need to be coated with an antistatic coating in a secondary operation. However, it is known that such antistatic coating layer may be transferred to the other surface and cause issues at the downstream converting process.

### SUMMARY OF THE INVENTION

A need exists for a safe to use oriented polyester film with an outer surface that is ultra smooth and another outer surface that is rougher so that the film is easy to handle. Further, the film should have antistatic properties that can easily, and in a controlled manner, discharge the electrostatic charges generated by the film handling process.

To overcome these issues, described is a polyester film whose outer coextruded layers cannot be peeled off from each other; one of its external layers may be ultra smooth while the other is rough. Either of its outer layers may contain a novel antistatic agent described herein which includes ionic/anionic chemistry.

One embodiment of such a film incorporates an antistatic agent including or consisting of an anionic/nonionic combination of surfactants in either or both of the outer film surfaces, and may also incorporate particles in the outer layers of a polyester film. An outer layer may have very small particles or no particles to provide a surface with very high gloss. The other outer layer may be rougher since it may have larger particles to reduce the coefficient of friction and make the film easy to handle.

The ultra smooth films with antistatic properties and ease of handling may be biaxially oriented multilayer polyester films for molding processes. This smooth, antistatic and easy to handle film may include an outer coextruded layer A, with or without particles, and an outer. coextruded B layer that includes particles. The particles may be polymeric particles, for example, cross-linked polystyrene, acrylic, polyamide, silica, calcium carbonate, alumina, titanium dioxide, clay and talc, or combinations thereof.

Layers A and B may include polyester. Layer A preferably has an Rq roughness from 1 nm to 8 nm. Layer B preferably has an Rq roughness from 10 nm to 60 nm. The Rq of layer B is preferably larger than layer A. Layer A preferably has a thickness of 10 to 60 micrometers, more preferably 15 to 60 micrometers. Layer B preferably has a thickness of 0.2 to 20 micrometers, more preferably from 0.5 to 5 micrometers. The antistatic property is provided by incorporating a combination of anionic and nonionic surfactants into layer A or B, or both, thus obtaining a surface resistivity lower than 1×10⁺¹¹ Ohm/square.

The concentration of anti-stat surfactant in any outer layer is preferably 1%-98% by weight of the antistat masterbatch in the total layer, more preferably 2%-50%, and most preferably 4%-30%. However, the concentration of anti-stat surfactant in any individual outer layer may depend on the layer thickness. Specifically, the concentration required to achieve a desired resistivity may need to be increased as the antistat layer approaches the low end of the layer thickness range so that the total amount of surfactant available in the layer is not the limiting factor in achieving a desired resistivity.

In addition, the film may include one or more additional layers such as adhesion promotion layers, release layers, oligomeric protective layers, or combinations thereof. Layer A may be further functionalized with adhesion promotion, release properties, hard coating, abrasion protection, antibacterial properties, embossability, or a combination thereof. These additional layers may be applied either during or after the biaxially oriented film has been fabricated.

One embodiment of a multi-layer biaxially oriented polyester film for molding processes may include an outer layer A having an Rq roughness from 1 nm to 8 nm and a thickness of 10 micrometers to 60 micrometers, preferably 15 to 60 micrometers, and an outer layer B having an Rq roughness from 20 nm to 60 nm and a thickness of 0.2 to 20 micrometers, preferably 0.5 to 5 micrometers, wherein at least layer A or layer B has a Surface Resistivity of less than 1×10⁺¹¹ Ohm/square provided by an anionic surfactant and nonionic surfactant combination that is impregnated into layer A or layer B, and the Rq of layer B is greater than layer A.

In some embodiments, the anionic surfactant and nonionic surfactant combination preferably does not transfer, diffuse, or migrate to any other surface once film making is complete. Layer A may include particles having an average volume diameter of less than 0.5 micrometers, layer B may include particles having an average volume diameter of less than 1 micrometer. The thickness of layer B may be less than 5 times the average volume diameter of the particles used in layer B. Preferably, layer B is thinner than layer A.

In some embodiments, layer A and/or layer B may include non-agglomerated particles. Non-agglomerated particles in layer A may include polymer particles, cross-linked polystyrene resin particles, cross-linked acrylic resin particles, polyimide particles, silica particles, calcium carbonate particles, alumina particles, titanium dioxide particles, clay particles, or talc particles. Non-agglomerated particles in layer B may include polymer particles, cross-linked polystyrene resin particles, cross-linked acrylic resin particles, polyimide particles, silica particles, calcium carbonate particles, alumina particles, titanium dioxide particles, clay particles, and talc particles. Layer A may be particle free.

In some embodiments, the film may further include one or more additional layers on a surface of layer A or layer B. These layers may be, for example, adhesion promotion layers, release layers, or oligomeric protective layers. The film may also include one or more additional inter layers between layer A and layer B. These inter layers may be particle free. An additional inter layer may include reclaimed polyester materials. Only layer B may include the anionic surfactant and nonionic surfactant combination in some embodiments.

The anionic surfactant and nonionic surfactant combination may include a nonionic surfactant selected from the group consisting of cetostearyl alcohol, stearyl alcohol, oleyl alcohol, cetyl alcohol, pentaethylene glycol monododecyl ether, polyoxypropylene glycol alkyl ethers, octaethylene glycol monododecyl ether, lauryl glucoside, polyoxyethylene glycol octylphenol ethers, octyl glucoside, and decyl glucoside. The anionic surfactant and nonionic surfactant combination may include an anionic surfactant selected from the group consisting of perfluorooctanesulfonate, perfluorobutanesulfonate, alkyl benzene sulfonates, dioctyl sodium sulfosuccinate, alkyl ether phosphate, alkyl aryl ether phosphate, sodium stearate; perfluorononanoate, perfluorooctanoate, sodium lauroyl sarcosinate, sodium myreth sulfate, sodium lauryl sulfate, sodium laureth sulfate, and ammonium lauryl sulfate.

An embodiment of a method of making a multi-layer biaxially oriented polyester film may include co-extruding a film including an outer layer A having an Rq roughness from 1 nm to 8 nm and a thickness of 10 micrometers to 60 micrometers, and an outer layer B having an Rq roughness from 20 nm to 60 nm and a thickness of 0.2 to 20 micrometers; and biaxially orienting the film. At least layer A or layer B may have a Surface Resistivity of less than 1×10⁺¹¹ Ohm/square provided by an anionic surfactant and nonionic surfactant combination that is impregnated into layer A or layer B, and the Rq of layer B is greater than layer A. Additional may be applied to a surface of layer A or layer B, for example, through co-extrusion or coating. Additional interlayer may be co-extruded between layer A and layer B.

### DETAILED DESCRIPTION OF THE INVENTION

Described are biaxially oriented coextruded multilayer polyester films that can be readily fabricated, have ultra smoothness, ease of handling, and antistatic properties for use in molding processes. To fabricate this highly specialized film with special surface properties any standard method to fabricate co-extruded biaxially oriented multilayer films may be employed.

The polyester materials can be prepared by any known method. These materials may include aromatic dicarboxylic acid as a main acid component and an aliphatic glycol as a main acid component. Examples of aromatic dicarboxylic acid are terephthalic acid, napthalenedicarboxyl acid, isophthalic acid and the like. Examples of aliphatic glycol are ethylene glycol, trimethylene glycol, cyclohexane dimethanol and the like.

An embodiment of the invention may include at least a two layer coextruded polyester film, that may include an ultra-smooth layer A, and a rough layer B. Rq, root-mean-square roughness is used to represent the smoothness of the surface properties of the films because it enhances influence of larger protrusions, which can produce an undesirable appearance in high-end, glossy, in-molded parts. Layer A may have an Rq roughness from 1 nm to 8 nm and a thickness of 10 micrometers to 60 micrometers. The preferred Rq roughness level for layer A is 3 to 6 nm. Layer B may have an Rq roughness from 20 nm to 60 nm and a thickness of 0.2 to 20 micrometers.

Further, the Rq of layer A is preferably less than one tenth of the roughness of layer B. If the roughness of layer B is too large as compared to layer A, the roughness of the layer B may be transferred through layer A, thus causing molded parts with poor gloss due to the high temperatures and pressures that develop during an in-molding operation.

The particles used in the ultra smooth layer A may include any particles whose volume average particle diameter is less than 0.5 micrometers. The rougher layer B may have particles whose volume average diameter is 0.3 to 1.5 micrometers. As examples, these particles may be calcium carbonate, alumina, silica, talc, titanium dioxide, clay, acrylic, polyamide, polymeric such as cross-linked polystyrene, or combinations thereof These inorganic and organic particles may be used singly or in combinations in layers A and B. It is preferable that these particles are non-agglomerated. The above characteristic will facilitate improved control of protrusions and surface properties.

In addition, other embodiments may include one or more inner layers in between the outermost A and B layers, such as an A/C/B structure. These inner layers preferably do not unduly influence the surface properties of layers A and B. The inner layer may contain no particles in order to minimize the influence on the surface roughness of layer A or B.

The inner layer may contain reclaimed polyester resin to reduce cost. Even though outer layers A and B will be covering said inner layer, minimizing any negative influence of the inner layer containing reclaimed polyester, the selection of reclaimed polyester and content thereof should be controlled in order not to unduly influence the surface properties that layers A and B give to the present invention.

Additional coating layers may be added onto layers A or B to give additional functionalities that should not compromise the ultra smoothness, antistatic and ease of handling. These additional layers may be adhesion promotion layers, release layers, oligomeric protective layers, or combinations thereof Layer A may be further functionalized with adhesion promotion, release properties, hard coating, abrasion protection, antibacterial properties, embossability, or a combination thereof

In molding applications, the rougher layer B contacts the mold, and the part is molded onto the ultra smooth thicker layer A. Consequently, this film should be easy to handle to enable rapid and correct positioning of the film in the molding machine. The molded part produced will possess high gloss on its surface. Any electrostatic charge generated during the handling of the film will be promptly dissipated in a controlled and safe manner via the antistat properties on the surface of the film.

In the present invention, either or both surfaces may have a Surface Resistivity of less than 1×10⁺¹² Ohm/square, preferably less than ×10⁺¹¹ Ohm/square, more preferably less than 1×10⁺¹⁰ at the condition described in Test Methods. Films may achieve the antistatic property by a nonionic/anionic combination of surfactants. The surfactants may be impregnated and embedded into layer A or B to prevent the surfactant from transferring to the opposite surface. For cost effectiveness it is preferable that the antistatic surfactant is contained only in layer B, which is thinner than layer A. It may be sufficient if the antistatic property is only on the surface of the layer B, which is the layer that contacts the mold surface where typically the film sticks and causes problems related to static buildup and discharge.

Some examples of nonionic surfactants include cetostearyl alcohol, stearyl alcohol, oleyl alcohol, cetyl alcohol, pentaethylene glycol monododecyl ether, polyoxypropylene glycol alkyl ethers, octaethylene glycol monododecyl ether, lauryl glucoside, polyoxyethylene glycol octylphenol ethers, octyl glucoside, and decyl glucoside.

Some examples of anionic surfactant include perfluorooctanesulfonate, perfluorobutanesulfonate, alkyl benzene sulfonates, dioctyl sodium sulfosuccinate, alkyl ether phosphate, alkyl aryl ether phosphate, sodium stearate; perfluorononanoate, perfluorooctanoate, sodium lauroyl sarcosinate, sodium myreth sulfate, sodium lauryl sulfate, sodium laureth sulfate, and ammonium lauryl sulfate.

The combination of nonionic and anionic surfactants dispersed throughout one or more layers of the multilayer film forms a molecularly connected network that provides paths of conductivity in the film. The enhancement of the formation of an antistatic network at the surface of a film to thus achieve the preferred level of low Surface Resistivity is important. The formation of the antistatic network at the surface of the biaxially oriented film is best enhanced by heat setting the film at temperatures within the range of 210 to 250 degrees Celsius.

There are a number of companies that produce master batches of anti-stat compounds in PET for example, T7910 from TORAY Industries, Inc. containing Sodium dodecylbenzenesulfonate, Tas1125 from Sukano'containing an aliphatic sulphonate, or ELECUT S618-A1 from Takemoto Oil and Fat containing a proprietary mixture of nonionic and anionic surfactants. In the present invention, ELECUT S618-A1 from Takemoto is preferred.

A surprising result of heat setting the film is that there appears to be some migration of anti-stat surfactants from Layer B through to the surface of layer A. However, once the heat set is complete and the film is finished and wound into roll form there appears to be no further migration of surfactants.

The concentration of anti-stat surfactant in any outer layer, by weight of the masterbatch in the total layer, is preferably 1%-98%, more preferably 2%-50%, and most preferably 4%-30%. It is of particular interest that the concentration of anti-stat surfactant required in any individual outer layer may depend on the layer thickness. Specifically, the concentration required to achieve a desired resistivity may need to be increased as the antistat layer approaches the low end of the layer thickness range so that the total amount of surfactant available in the layer is not the limiting factor in achieving a desired resistivity. In the present invention where an outer antistat layer is 3-5 microns, the amount of antistat masterbatch is preferably 4-30%, more preferably 5-20%, and most preferably 6-10%.

### EXAMPLES

This invention will be better understood with reference to the following examples, which are intended to illustrate specific embodiments within the overall scope of the invention.

### Test Methods

### Thickness

A Digital Optical Microscope was used to measure the thicknesses of each coextruded layer of the multilayer film as well as its total thickness in the following manner. A color tracer was incorporated into one of the film layers to clearly differentiate one layer from the other. Next, along a plane that was vertical and along the transverse direction of the film, sections were cut to generate small cross-sectional pieces of film. Next, a digital microscope was used to measure the thickness of each coextruded layer and the total film thickness as well.

### Surface Roughness

Surface roughness was measured by a non-contact 3-D roughness meter “Zygo NewView 7000”. The polyester films were cut and stretched tight to make the film flat. The prepared film was put on the stage of the roughness meter and measured using below Measurement Controls, and then the roughness was analyzed using below. The measurement and analysis were repeated 3 times and the average value of SRq, 3-D root-mean-square roughness, was used to represent the roughness. Rq, root-mean-square roughness is used to represent the smoothness of the surface properties of the films because it enhances influence of larger protrusions, which are not desirable for high-end, glossy, appearance in-molded parts.

Measurement Controls

Acquisition Mode: Scan

Camera Mode: 320×240 380 Hz

Scan Direction: Downward

Scan Length: 5 micron bipolar (1 sec)

Phase Resolution: High

Connection Order: Location

Discon Action: Filter

Min Mod (%): 3.00

Min Area Size: 20

Image Zoom: 0.5×

Remove Fringes: On

Analyze Controls

High FFT Filter: Off

Low FFT Filter: Fixed

Low Filter Wavelength: 200 micron meter

### Coefficient of Friction

It was measured by employing an instrument from Testing Machine Inc., Model No. 32-06. This test requires that a narrow long piece of the film be fixed onto a glass surface, and another smaller piece of the film is fixed to a carriage of known weight. Next, the exposed surfaces of the pieces of film are put into contact and the carriage is dragged along. From the static position the force to get the carriage into motion is measured, as well as the dynamic force to keep it on sliding. The static and dynamic coefficients of frictions are determined as the ratios of the forces measured and the known weight of the slide.

### Surface Resistivity

Measured with a concentric ring probe from TREK, Inc, Model No. 152. ASTM Standard D 257-99. The testing conditions were 25° C. at 50% of Relative Humidity.

### Surface Tension

It was determined by using a known numerical relationship between Surface Tension of a polymer surface and the contact angle of a pure water drop deposited onto the surface (Zisman correlation). The contact angle was measured by the Contact Angle Meter (U.S. Pat. No. 5,268,733) made by Tantec. Surface tension in dynes/cm.

### Example 1

For layers A and B, PET plus ingredients listed in Table 1 were mixed and dried. Each layer combination was fed to a different extruder and each melt flow was filtered. The extrusion zone temperatures were in the range of 260 to 290 degrees Celsius. Said melt flows entered a melt distributor that overlaid each melt flow over one another to form an (A)/(B) structure that entered a flat die set at about 270 degrees Celsius. The melt curtain exiting the die dropped and was electro-statically pinned onto a rotating chilled cast roll set at about 20 degrees Celsius causing the curtain to solidify into a continuously moving amorphous sheet. This sheet entered a set of rotating heated rolls which had speed differentials among them. Said rolls were set to about 80 to 90 degrees Celsius, and the traveling sheet was oriented about 3 times in the machine direction. Next, this machine-direction oriented sheet traveled into a multi-zone enclosed heated oven, where the machine-direction oriented film was first preheated to a temperature of about 80 degrees Celsius in the first zone of the oven. At the next zone set to about 90 degrees Celsius the moving film was oriented about 4 times, and next relaxed by about 5% in the relaxation zone of the oven. Next the biaxially oriented and relaxed film entered a zone set to about 230 degrees Celsius to heat set the film. The resulting bi-layer (A)/(B) film was wound up into a roll, cut into sheets and stored for 2 months. The film obtained has the dimensions and surface properties shown in Table 1. The film has an ultra-smooth surface A, and a rougher surface B, with the coefficients of friction being below 0.5 indicating that this film possesses good handling characteristics. The ultra-smooth layer A is insulating, while the rough B layer has a lower surface resistivity hereby rendering the surface antistatic. Each layer maintains their respective surface tension properties over time indicating that the antistatic additive does not diffuse nor migrate from layer B to layer A once the film is made. The Surface Tension results also indicate that the antistat additive remains immobile at the surface and does not transfer to the backside, layer A, through contact of the films layers in roll form.

### Example 2

A two-layer biaxially oriented polyester film produced in the same manner as described in Example 1. The film obtained has the dimensions and surface properties shown in Table 1. Similar to Example 1, the film has an ultra-smooth surface A, and a rougher surface B with the coefficients of friction being below 0.5 indicating that this film possesses good handling characteristics. The ultra-smooth layer A is insulating, while the rough B layer has a lower surface resistivity hereby rendering the surface antistatic. The anionic/nonionic surfactant mixture (Takemoto ELECUT S618-A1) provides improved anti-static properties by an order of magnitude over the Sodium dodecylbenzenesulfonate used in Example 1. Similar to Example 1, however, each layer maintains their respective surface tension properties over time indicating that the antistatic additive does not diffuse nor migrate from layer B to layer A once the film is made The Surface Tension results also indicate that the antistat additive remains immobile at the surface and does not transfer to the backside, layer A, through contact of the films layers in roll form.

### Example 3

A two-layer biaxially oriented polyester film produced in the same manner as described in Examples land 2. Example 3 has the same anionic/nonionic surfactant mixture as Example 2 (Takemoto ELECUT S618-A1) but the concentration was increased from 1.2% to 2.0%. As is evident from the surface resistivity data in table 1, an increase in anionic/nonionic anti-stat surfactants did not reduce the resistivity beyond the level measured in Example 2. Example 3 also shows that with the increase in anionic/nonionic surfactants there was no migration through the layers or transfer to the opposite, A-layer, side of the film.

### Examples 4

A two-layer biaxially oriented polyester film produced in the same manner as described in Examples 1, 2, and 3. The film obtained has the dimensions and surface properties shown in Table 1. Similar to Example 1, 2, and 3, the film has an ultra-smooth surface A, and a rougher surface B. In the case of Example 4, anti-static agent Sodium dodecylbenzenesulfonate has been added to both layers A and B rendering both surfaces antistatic.

### Examples 5

A two-layer biaxially oriented polyester film produced in the same manner as described in Examples 1-4. The film obtained has the dimensions and surface properties shown in Table 1. Similar to Examples 1-4, the film has an ultra-smooth surface A, and a rougher surface B. In the case of Example 5, the anionic/nonionic anti-stat surfactant mixture (Takemoto ELECUT S618-A1) has been added to both layers A and B rendering both surfaces antistatic.

### Example 6

### Comparative Example

A biaxially oriented polyester film was produced in the same manner as described in Examples 1-5. The resulting bilayer (A)/(B) film was wound up into a roll, cut into sheets and stored for 2 months. The film has dimensions and properties as shown in Table 1 and has an ultra-smooth surface A, and a rougher surface B. Table 1 shows that both the ultra-smooth layer A, as well as the rough layer B are insulating since neither layer has any antistatic additive. Interestingly, Layer A of this comparative example has a higher resistivity by two orders of magnitude than Layer A of Examples 1, 2, and 3. This demonstrates that there must be some migration of anti-stat surfactants from Layer B of examples 1, 2, and 3, through to the surface of layer A in the same examples.

TABLE 1

| | | | | | Surface Resist | |
|---|---|---|---|---|---|---|
| Example | Gauge | | Layer Composition | | 25° C., 50% RH | |
| Layer | A | B | A | B | A | B |
| 1 | 28 | 5 | PET with 0.06% Styrene | PET with 1.5% 0.9 mm CaCO₃ | 1.6E+14 | 1.1E+11 |
| | | | Disphenol A diglycidyl ether | and 0.48% Sodium | | |
| | | | Dimethyl copolymer | dodecylbenzenesulfonate | | |
| 2 | 28 | 5 | PET with 0.06% Styrene | PET with 1.5% 0.9 mm CaCO_{3.} | 6.5E+14 | 1.2E+10 |
| | | | Disphenol A diglycidyl ether | 1.2% of an anionic/nonionic | | |
| | | | Dimethyl copolymer | surfactant mixture. | | |
| 3 | 28 | 5 | PET with 0.06% Styrene | PET with 1.5% 0.9 mm CaCO_{3.} | 5.7E+14 | 1.2E+10 |
| | | | Disphenol A diglycidyl ether | 2.0% anionic/nonionic | | |
| | | | Dimethyl copolymer | surfactant mixture. | | |
| | | | | 1% of 2.4 mm silica. | | |
| 4 | 28 | 5 | PET with 0.06% Styrene | PET with 1.5% 0.9 mm CaCO₃ | 1.6E+11 | 8.0E+10 |
| | | | Disphenol A diglycidyl ether | and 0.48% Sodium | | |
| | | | Dimethyl copolymer and | dodecylbenzenesulfonate | | |
| | | | 0.48% Sodium | | | |
| | | | dodecylbenzenesulfonate | | | |
| 5 | 28 | 5 | PET with 0.06% Styrene | PET with 1.5% 0.9 mm CaCO_{3.} | 1.1E+10 | 1.6E+10 |
| | | | Disphenol A diglycidyl ether | 1.2% of an anionic/nonionic | | |
| | | | Dimethyl copolymer. | surfactant mixture. | | |
| | | | 1.2% of an anionic/ | | | |
| | | | nonionic surfactant mixture | | | |
| 6 | 28 | 5 | PET with 0.06% Styrene | Comparative example | 3.1E+16 | 1.8E+16 |
| | | | Disphenol A diglycidyl ether | PET with 1.5% 0.9 mm CaCO3. | | |
| | | | Dimethyl copolymer | No anti-stat surfactants | | |

| | Surface Tension | | Surface Tension | | Coefficient of | | | |
|---|---|---|---|---|---|---|---|---|
| | At time = 0 | | Aged 8 wks | | Friction | | ZYGO Rq (nm) | |
| Example | by contact angle | | by contact angle | | Layer A onto B | | Low FFT filter | |
| Layer | A | B | A | B | μs | μd | A | B |
| 1 | 40 | >53.5 | >53.5 | >53.5 | 0.44 | 0.37 | 5.4 | 48.4 |
| 2 | 41 | >53.5 | 41 | >53.5 | 0.45 | 0.37 | 5.4 | 52.7 |
| 3 | 41 | >53.5 | 41 | >53.5 | 0.47 | 0.37 | 5.3 | 49.3 |
| 4 | >53.5 | >53.5 | >53.5 | >53.5 | 0.55 | 0.39 | 6.4 | 55.6 |
| 5 | >53.5 | >53.5 | >53.5 | >53.5 | 0.46 | 0.37 | 6.6 | 44.6 |
| 6 | 40 | 40 | 40 | 40 | 0.39 | 0.36 | 5.5 | 45.2 |

This application discloses several numerical ranges in the text and figures. The numerical ranges disclosed inherently support any range or value within the disclosed numerical ranges even though a precise range limitation is not stated verbatim in the specification because this invention can be practiced throughout the disclosed numerical ranges.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

We claim:

1. A multi layer biaxially oriented polyester film for molding processes comprising:
an outer layer A having an Rq roughness from 1 nm to 8 nm and a thickness of 15 micrometers to 60 micrometers; and
an outer layer B having an Rq roughness from 20 nm to 60 nm and a thickness of 0.5 to 5 micrometers,
wherein at least layer A or layer B has a Surface Resistivity of less than 1×10⁺¹¹ Ohm/square provided by an anionic surfactant and nonionic surfactant combination that is impregnated into layer A or layer B, and the Rq of layer B is greater than layer A.

2. The film of claim 1, wherein the anionic surfactant and nonionic surfactant combination does not transfer, diffuse, or migrate to any other surface once film making is complete.

3. The film in claim 1, wherein layer A comprises particles having an average volume diameter of less than 0.5 micrometers.

4. The film in claim 1, wherein layer B comprises particles having an average volume diameter of less than 1 micrometer.

5. The film in claim 1, wherein the thickness of layer B is less than 5 times the average volume diameter of the particles used in layer B.

6. The film of claim 1, wherein layer A comprises non-agglomerated particles.

7. The film of claim 1, wherein layer B comprise non-agglomerated particles.

8. The film of claim 6, wherein the particles are selected from the group consisting of polymer particles, cross-linked polystyrene resin particles, cross-linked acrylic resin particles, polyimide particles, silica particles, calcium carbonate particles, alumina particles, titanium dioxide particles, clay particles, and talc particles.

9. The film of claim 7, wherein the particles are selected from the group consisting of polymer particles, cross-linked polystyrene resin particles, cross-linked acrylic resin particles, polyimide particles, silica particles, calcium carbonate particles, alumina particles, titanium dioxide particles, clay particles, and talc particles.

10. The film of claim 1, wherein layer A is particle free.

11. The film of claim 1, further comprising an additional layer on a surface of layer A or layer B selected from a group consisting of an adhesion promotion layer, a release layer, and an oligomeric protective layer.

12. The film of claim 1, further comprises an inter layer between layer A and layer B.

13. The film of claim 12, wherein the inter layer is particle free.

14. The film of claim 12, wherein the additional inter layer comprises reclaimed polyester materials.

15. The film of claim 1, wherein only layer B comprises the anionic surfactant and nonionic surfactant combination.

16. The film of claim 1, wherein the anionic surfactant and nonionic surfactant combination comprises a nonionic surfactant selected from the group consisting of cetostearyl alcohol, stearyl alcohol, oleyl alcohol, cetyl alcohol, pentaethylene glycol monododecyl ether, polyoxypropylene glycol alkyl ethers, octaethylene glycol monododecyl ether, lauryl glucoside, polyoxyethylene glycol octylphenol ethers, octyl glucoside, and decyl glucoside.

17. The film of claim 1, wherein the anionic surfactant and nonionic surfactant combination comprises an anionic surfactant selected from the group consisting of perfluorooctanesulfonate, perfluorobutanesulfonate, alkyl benzene sulfonates, dioctyl sodium sulfosuccinate, alkyl ether phosphate, alkyl aryl ether phosphate, sodium stearate; perfluorononanoate, perfluorooctanoate, sodium lauroyl sarcosinate, sodium myreth sulfate, sodium lauryl sulfate, sodium laureth sulfate, and ammonium lauryl sulfate.

18. A method of making a multi layer biaxially oriented polyester film comprising:
co-extruding a film comprising an outer layer A having an Rq roughness from 1 nm to 8 nm and a thickness of 15 micrometers to 60 micrometers, and an outer layer B having an Rq roughness from 20 nm to 60 nm and a thickness of 0.5 to 5 micrometers; and
biaxially orienting the film,
wherein at least layer A or layer B has a Surface Resistivity of less than 1×10⁺¹¹ Ohm/square provided by an anionic surfactant and nonionic surfactant combination that is impregnated into layer A or layer B, and the Rq of layer B is greater than layer A.

19. The method of claim 18, wherein layer A comprises particles having an average volume diameter of less than 0.5 micrometers.

20. The method of claim 18, wherein layer B comprises particles having an average volume diameter of less than 1 micrometer.

21. The method of claim 18, wherein the thickness of layer B is less than 5 times the average volume diameter of the particles used in layer B.

22. The method of claim 18, wherein layer A comprises non-agglomerated particles.

23. The method of claim 18, wherein layer B comprise non-agglomerated particles.

24. The method of claim 18, wherein layer A is particle free.

25. The method of claim 18, further comprising applying an additional layer on a surface of layer A or layer B.

26. The method of claim 18, further comprising co-extruding one or more additional inter layers between layer A and layer B.

27. The method of claim 18, wherein layer B is thinner than layer A.
